(19) United States
(12) Patent Application Publication
(10) Pub. No.: US 2026/0250005 A1
(43) Pub. Date: Aug. 27, 2026

(54) Multivariable Control of Hybrid-electric Propulsion System

(71) Applicant: General Electric Company, Evendale, OH (US)

(72) Inventors: Stefan Joseph Cafaro, Chapel Hill, NC (US); Gang Yao, Dallas, TX (US)

(21) Appl. No.: 19/060,341

(22) Filed: Feb. 21, 2025

(51) Int. Cl. B64D 31/18; B64D 27/33

(52) U.S. Cl. CPC B64D 31/18; B64D 27/33

(57) ABSTRACT

An electric machine control system and methods for operating a hybrid-electric propulsion system are described herein. An electric machine control system may include at least one electric machine controller that directs first and second electric machines to apply a positive or negative torque to respective first and second engine shafts in accordance with a demanded electric machine torque and/or a demanded electric bus voltage. The electric machine controller may be configured to reject disturbances introduced by one or more electric machines due to cross-coupled effects thereof. Using the systems and methods for rejecting disturbances described herein, tighter tolerances can be achieved for torque delivered or extracted by the electric machine(s) while reducing voltage droop on the electrical bus during transients.

### TECHNICAL FIELD

The present subject matter relates generally to a hybrid-electric propulsion system, and more particularly to systems and methods for controlling hybrid-electric propulsion systems and electric machines thereof of aircraft and aircraft engines.

### BACKGROUND

Commercial aircraft generally include a propulsion system that provides thrust. The propulsion system typically includes at least two engines, such as turbofan jet engines mounted to each wing of the aircraft. Hybrid-electric propulsion systems are being developed to improve the efficiency and performance of commercial aircraft. Various hybrid-electric propulsion systems include at least one electric machine driven by one of the aircraft engines. Electric machines, e.g., controllable electric motor/generators can provide additional thrust power to the engine, transfer power between shafts in a multi-spool engine, and/or generate electricity for use by the engine or other aircraft systems. The present disclosure relates to improvements to the control and operation of electric machines and the engines of which they are a part in a hybrid-electric propulsion system.

### BRIEF DESCRIPTION OF DRAWINGS

Various needs are at least partially met through provision of the electric machine control systems and methods for operating hybrid-electric propulsion systems described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is a cross-sectional view of a gas turbine engine for an aircraft in accordance with various embodiments of these teachings;

FIG. 2 is a schematic representation of a hybrid-electric propulsion system including a gas turbine engine and a first electric machine connected to a low pressure shaft and a second electric machine connected to a high pressure shaft of the gas turbine engine as configured in accordance with various embodiments of these teachings;

FIG. 3 is a block diagram of an electric machine control system as configured in accordance with various embodiments of these teachings;

FIG. 4 is a block diagram of an electric machine control system configured for a one-way disturbance rejection for torque control due to voltage loop as configured in accordance with various embodiments of these teachings;

FIG. 5 is a block diagram of an electric machine control system configured for a one-way disturbance rejection for electric bus voltage control due to torque loop as configured in accordance with various embodiments of these teachings;

FIG. 6 is a block diagram of an electric machine controller as configured in accordance with various embodiments of these teachings;

FIG. 7 is a block diagram of an electric machine control system implementing distributed Multi-Input Multi-Output (MIMO) controllers as configured in accordance with various embodiments of these teachings;

FIG. 8 is a block diagram of an electric machine control system implementing a single dedicated Multi-Input Multi-Output (MIMO) controller as configured in accordance with various embodiments of these teachings;

FIG. 9 is a block diagram of an electric machine control system for a hybrid-electric propulsion system of an aircraft as configured in accordance with various embodiments of these teachings;

FIG. 10 is a flow diagram of a method for operating a hybrid-electric propulsion system in accordance with various embodiments of these teachings;

FIG. 11 are graphs of an electric bus voltage and high pressure and low pressure electric machine torques over time for both a prior art hybrid-electric propulsion system and a hybrid-electric propulsion system in accordance with various embodiments of these teachings;

FIG. 12 is a schematic diagram of an electric machine controller in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Turbofan and turboprop jet engines rely primarily on a primary engine controller such as a Full-Authority Digital Engine Control (FADEC) or an Electronic Engine Controller (EEC) to control the operating parameters of the engine or engines. Such primary engine controllers generally have control authority over the operation of one or more electric machines of a hybrid-electric engine. In some hybrid-electric engines, a plurality of electric machines are operably connected to the engine shafts. For example, a first electric machine is operably coupled to first engine shaft, such as a low pressure shaft or spool, and a second electric machine is operably coupled to a second engine shaft, such as a high pressure shaft or spool. The FADEC provides control signals to the one or more secondary controllers, such as one or more electric machine controllers, to control the operation of the electric machines substantially in accordance with the control signals. In some forms, the electric machines may be directly controlled by a single integrated electric machine controller, which may also be referred to as an Inverter Converter Controller (ICC), based on control signals provided by the FADEC. In other forms, each electric machine is directly controlled by a distributed electric machine controller based on control signals from the FADEC.

In some embodiments, the FADEC controls whether each electric machine is operated in one of at least two modes, such as a torque mode or a voltage mode. In torque mode, the electric machine controller operates the electric machine to maintain a demanded torque applied to or extracted from an engine shaft. For an electric machine operated in a positive torque mode, the FADEC will provide a control reference signal corresponding to a demanded torque that the electric machine is to inject to the engine shaft to which it is connected. In a negative torque mode, the FADEC provides a control reference signal corresponding to a demanded torque that the electric machine is to extract from the engine shaft to which it is connected. Generally, an electric machine in positive torque mode uses electric energy supplied by another electric machine and/or a battery to inject torque to the connected engine shaft, thereby generating additional thrust, while an electric machine in negative torque mode extracts torque from the connected engine shaft to generate electricity that is supplied to an electric bus of the engine and/or the aircraft. The generated electricity may also be used to power another electric machine and/or to charge a battery.

For an electric machine operated in a voltage mode, the FADEC provides a control reference signal to the electric machine controller corresponding to a demanded electric bus voltage that the electric machine is to maintain by selectively extracting torque from the engine shaft to which the electric machine is connected to generate and supply electric power to an electric bus of the engine, another electric machine, and/or the aircraft. As described in additional detail below, in some embodiments, the electric machine controller in voltage mode implements at least two control loops, an outer voltage control loop for determining a current demand for the electric machine corresponding to the desired voltage on the electric bus based on a sensed or estimated bus voltage and an inner torque or current control loop for controlling the torque applied or extracted from the engine shaft by the electric machine based on the current demand determined in the voltage control loop. In some instances, one of the electric machines is operated in torque mode, while another electric machine is operated in voltage mode. In other instances, two or more electric machines may each be operated in torque mode or in voltage mode.

In a hybrid-electric engine having first and second electric machines connected to first and second engine shafts, such as a low pressure shaft and a high pressure shaft, the electric machines operate on a shared physical network of the engine and as a result are subject to cross-coupled effects. For example, the torque of the high pressure shaft has a direct effect on the torque of the low pressure shaft and changes in the torque of one shaft will affect the torque of the other. Accordingly, when a first electric machine changes the speed of a first shaft by injecting or extracting torque, the speed of the second shaft will also change, causing a second electric machine connected to the second shaft that is attempting to maintain an injected or extracted torque to change the torque that the second electric machine is extracting from or injecting to the second shaft.

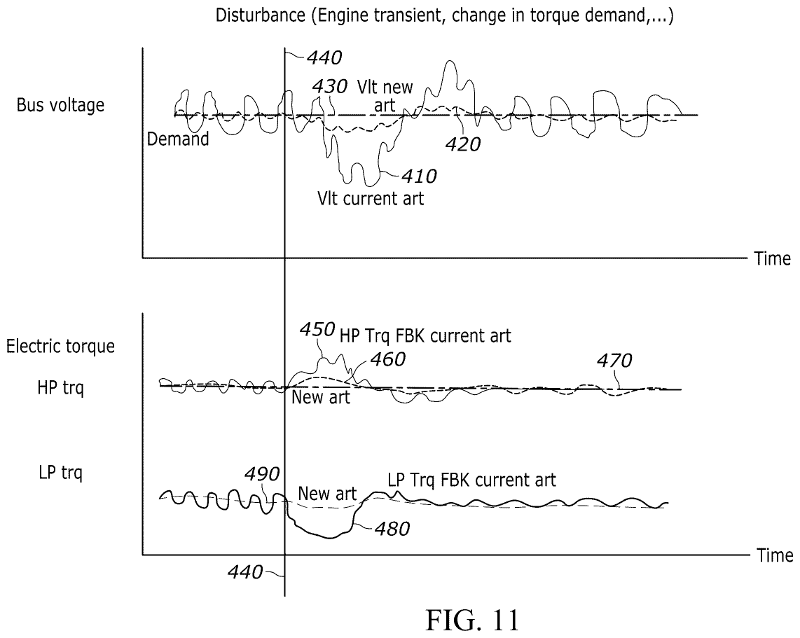

For example, if the FADEC causes the engine to quickly accelerate while a constant aircraft power load is pulled off the electrical bus, the following scenario illustrating the cross-coupled effects of the electric machines might ensue. An electric machine controller controlling a first electric machine in voltage mode connected to the low pressure shaft detects a power increase to the electrical bus as the low pressure shaft speed increases and therefore causes the first electric machine to decrease the torque extracted from the low pressure shaft in order to reduce the power supplied to the electrical bus. By decreasing the torque extracted from the low pressure shaft, the speed of the low pressure shaft increases faster. This increases the air flow to the engine core and causes the high pressure shaft speed to increase. At the same time, if the electric machine controller (or a second electric machine controller) is controlling a second electric machine connected to the high pressure shaft in torque mode to inject a constant torque to the high pressure shaft, the electric machine controller will cause the second electric machine to increase the torque to keep up with the increased speed of the high pressure shaft. However, when the second electric machine increases its torque, the electric bus voltage drops further due to the increased electrical demand from the second electric machine. Accordingly, the electric machine controller will increase the torque extracted from the low pressure shaft by the first electric machine to compensate for the drop in the electric bus voltage. In other words, the coupling effects of the electric machines can cause difficulties in maintaining a desired torque and/or voltage, particularly during engine and/or aircraft load transients. In particular, undesired oscillations and perturbations to the torque output of the electric machines and a resulting electric bus voltage can occur. Such oscillations to an electric bus voltage and electric machine torque are illustrated in FIG. 11 and described in further detail below.

Advantageously, the electric machine controller(s) can be configured to reject such above-described disturbances caused by transients significantly more effectively than by the FADEC itself. Compared to the electric machine controller(s), the FADEC is relatively slow to respond to disturbances. In addition, the oscillations and perturbations resulting from the coupling effects occur at frequencies that are too high for the FADEC to effectively address. For example, the FADEC may operate in a frequency range of 1-100 Hz, such as 67 Hz, while the electric machine controller or controllers may operate in the kilohertz range, such as 1-100 kHz, and in some forms 10-20 kHz. This means that the electric machine controller(s) operate at orders of magnitude faster than the FADEC. The inventors discovered that by configuring and/or programming the electric machine controller or controllers to compensate for the coupling effects of each electric machine on the other, tighter tolerances for the delivered torque and a reduction in electric bus voltage droop (or spike) could be accomplished compared with disturbance rejection effected by the FADEC alone. In accordance with some embodiments, the electric machine controller(s) can schedule changes to the applied or extracted torques of the electric machines simultaneously, i.e., within 2 ms, to compensate for disturbances resulting from the above-described coupling effects.

The instant disclosure describes systems and methods for improving voltage and torque tracking for hybrid-electric engine architectures with multiple electric machines. In some embodiments, systems and methods described herein integrate formerly independent voltage and torque controllers so that their disturbances on one another can be accounted for. For example, an integrated electric machine controller (ICC) or multiple distributed power converter controllers control engine shaft torque and electrical bus voltage using electric machine torque. In some forms, one or more electric machine controllers, also referred to as a power converter controllers, are configured as multiple input, multiple output (MIMO) controllers. In other forms, one of at least two electric machine controllers implements a disturbance rejection control technique to reject disturbances introduced by one of the electric machines. In some embodiments, the demands and feedbacks across multiple electric machines can be used to compensate for the impact of the injected or extracted torque of one electric machine on another electric machine. In some embodiments, models of the effects of electric machine-provided torque on electric bus voltage and engine shaft torque during transient events, such as engine transients (i.e., an increase or decrease in thrust) or aircraft electrical load transients (i.e., a change in the electrical load on an electric bus due to changes in electrical demand by various aircraft systems, such as activation of an anti-ice system) are implemented to allow a dynamic inversion-based approach to be used to reject the disturbances to the control of an electric bus voltage or a torque by one or more electric machines caused by another electric machine's injected or extracted torque. Using such approaches, tighter tolerances can be achieved for torque delivered or extracted by the electric machine(s) while reducing voltage droop on the electrical bus during such transients.

Generally speaking, the various aspects of the present disclosure can be employed with an electric machine control system, including an electric machine controller that directs at least a first electric machine to apply a positive or negative torque to a first engine shaft to which the first electric machine is connected in response to a demanded first electric machine torque or a demanded electric bus voltage of an electric bus to which the first electric machine is connected. The electric machine controller adjusts the positive or negative torque applied by the first electric machine in response to at least one received signal to compensate for disturbances to an electric bus voltage of an electric bus to which the first electric machine is connected and/or a first engine shaft torque introduced thereto by a change in a torque applied by a second electric machine to a second engine shaft. The at least one received signal corresponds to at least one of a demanded second electric machine torque and a demanded electric bus voltage of an electric bus to which the second electric machine is connected. Such an electric machine control system can achieve tighter tolerances for torque delivered or extracted by the electric machines while reducing voltage droop on the electrical bus during transients.

The various aspects of the present disclosure can also be employed with a method for operating a hybrid-electric propulsion system of an aircraft, including an engine, a first electric machine coupled to a first engine shaft of the engine and a second electric machine coupled to a second engine shaft of the engine. The method includes: receiving a demanded torque output or a demanded electric bus voltage of the first electric machine, receiving a demanded torque output or a demanded electric bus voltage of the second electric machine, and determining a current demand corresponding to the demanded torque output or the demanded electric bus voltage for the first electric machine. Determining a current demand for the first electric machine includes adjusting the current demand for the first electric machine in response to the demanded torque output or the demanded electric bus voltage of the second electric machine to compensate for disturbances introduced by a change in a torque applied by the second electric machine to the second engine shaft. Such a method similarly allows a hybrid-electric propulsion system to achieve tighter tolerances for torque delivered or extracted by the electric machines while reducing voltage droop on the electrical bus during transients.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

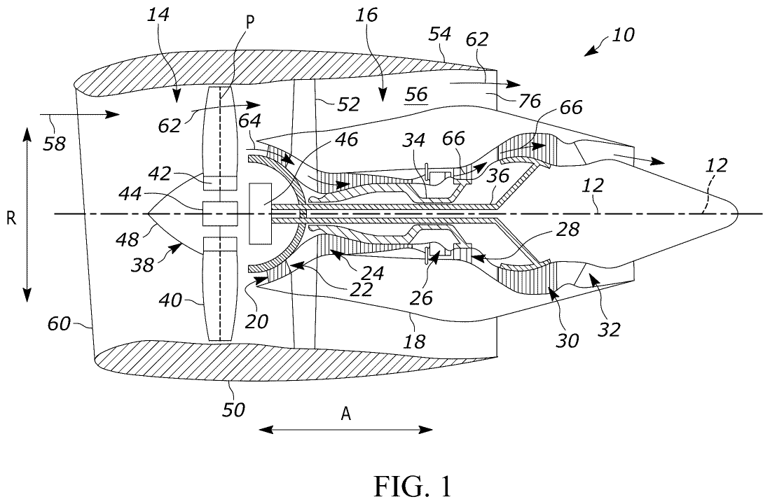

The foregoing and other benefits may become clearer upon making a thorough review and study of the following detailed description. Referring now to the drawings, wherein identical numerals indicate the same elements throughout the figures, FIG. 1 is a cross-sectional view of a gas turbine engine. The gas turbine engine is a high-bypass turbofan jet engine, referred to herein as “turbofan engine 10.” The turbofan engine 10 defines an axial direction A (extending parallel to a longitudinal centerline 12 provided for reference) and a radial direction R. In general, the turbofan engine 10 includes a fan section 14 and a core turbine engine 16 disposed downstream from the fan section 14.

The exemplary core turbine engine 16 depicted generally includes a substantially tubular outer casing 18 that defines an annular inlet 20. The tubular outer casing 18 encases, in serial flow relationship, a compressor section including a low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) spool 36 drivingly connects the LP turbine 30 to the LP compressor 22.

The fan section 14 includes a variable pitch fan 38 having a plurality of fan blades 40 coupled to a disk 42 in a spaced apart manner. As depicted, the fan blades 40 extend outwardly from disk 42 generally along the radial direction R. Each of the fan blades 40 is rotatable relative to the disk 42 about a pitch axis P by virtue of the fan blades 40 being operatively coupled to a suitable actuation member 44 configured to collectively vary the pitch of the fan blades 40 in unison. The fan blades 40, disk 42, and actuation member 44 are together rotatable about the longitudinal centerline 12 by low pressure spool 36 across a power gear box 46. The power gear box 46 includes a plurality of gears for stepping down the rotational speed of the LP spool 36 to a more efficient rotational fan speed. It will be appreciated that additional configurations for the fan section 14 such as those that employ a non-ducted or non-variable pitch design are also contemplated.

Referring still to the exemplary embodiment of FIG. 1, the disk 42 is covered by rotatable front hub 48 aerodynamically contoured to promote an airflow through the plurality of fan blades 40. Additionally, the exemplary fan section 14 includes an annular fan casing or outer nacelle 50 that circumferentially surrounds the variable pitch fan 38 and/or at least a portion of the core turbine engine 16. It should be appreciated that the outer nacelle 50 may be configured to be supported relative to the core turbine engine 16 by a plurality of circumferentially-spaced outlet guide vanes 52. Moreover, a downstream section 54 of the outer nacelle 50 may extend over an outer portion of the core turbine engine 16 to define a bypass airflow passage 56 therebetween.

During operation of the turbofan engine 10, a volume of air 58 enters the turbofan engine 10 through an associated inlet 60 of the outer nacelle 50 and/or fan section 14. As the volume of air 58 passes across the fan blades 40, a first portion 62 of the air 58 as indicated by arrow is directed or routed into the bypass airflow passage 56 and a second portion 64 of the air 58 as indicated by arrow is directed or routed into the LP compressor 22. The ratio between the first portion 62 of air 58 and the second portion 64 of air 58 is commonly known as a bypass ratio. The pressure of the second portion 64 of air 58 is then increased as it is routed through the HP compressor 24 and into the combustion section 26, where it is mixed with fuel and burned to provide combustion gases 66. Subsequently, the combustion gases 66 are routed through the hot flowpath, or hot-section flowpath, of the HP turbine 28 and the LP turbine 30, where a portion of thermal and/or kinetic energy from the combustion gases 66 is extracted.

The combustion gases 66 are then routed through the jet exhaust nozzle section 32 of the core turbine engine 16 to provide propulsive thrust. Simultaneously, the pressure of the first portion 62 of air 58 is substantially increased as the first portion 62 of air 58 is routed through the bypass airflow passage 56 before it is exhausted from a fan nozzle exhaust section 76 of the turbofan engine 10, also providing propulsive thrust.

It should be appreciated, however, that the exemplary turbofan engine 10 depicted in FIG. 1 is by way of example only, and that in other exemplary embodiments, aspects of the present disclosure may additionally, or alternatively, be applied to any other suitable gas turbine engine. For example, in other exemplary embodiments, the turbofan engine 10 may instead be any other suitable aeronautical gas turbine or hybrid-electric gas turbine engine, such as an unducted or open rotor turbofan engine, a turbojet engine, turboshaft engine, turboprop engine, etc. Additionally, in still other exemplary embodiments, the exemplary turbofan engine 10 may include or be operably connected to any other suitable accessory systems. Additionally, or alternatively, the exemplary turbofan engine 10 may not include or be operably connected to one or more of the accessory systems discussed above.

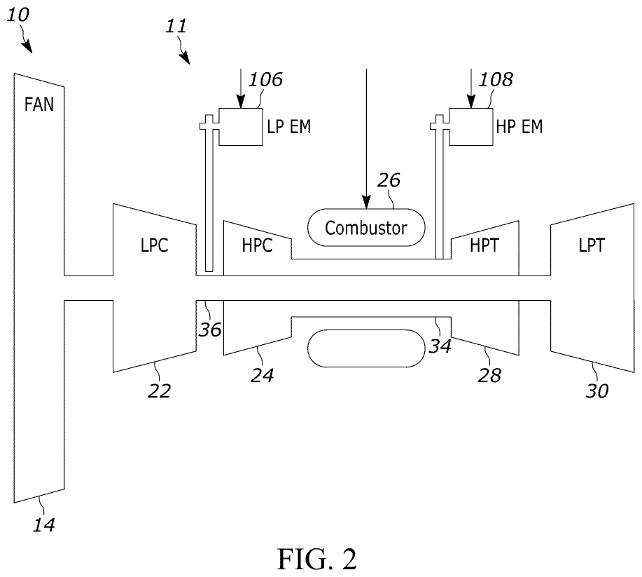

Now referring to FIG. 2, a schematic illustration of an exemplary turbofan or turboprop engine 10 of a hybrid-electric propulsion system 11 will be described. The turbofan engine 10 shown in FIG. 1 can additionally include a plurality of electric machines that are physically coupled (e.g., geared) to the spools or shafts of the turbofan engine 10 and used to apply positive torque to the shafts for thrust generation and negative torque to the shafts for power generation. In particular, the turbofan engine 10 can include a first low pressure electric machine 106 geared to the LP shaft 36 and a high pressure electric machine 108 geared to the HP shaft 34. In some embodiments, the low pressure electric machine 106 may be sized for power extraction, while the high pressure electric machine 108 may be sized for injecting torque, which can expand operability of the HP compressor 24 and also allows for electric startup of the engine 10. It should be appreciated that additional or fewer electric machines can be coupled to the LP shaft 36 and/or the HP shaft 34 and be controlled according to the systems and methods described herein. Further, it will also be appreciated that embodiments with additional spools or shafts, beyond the LP spool shaft and/or the HP shaft 34, that also include associated electric machines operable by the electric machine control system 100 are contemplated.

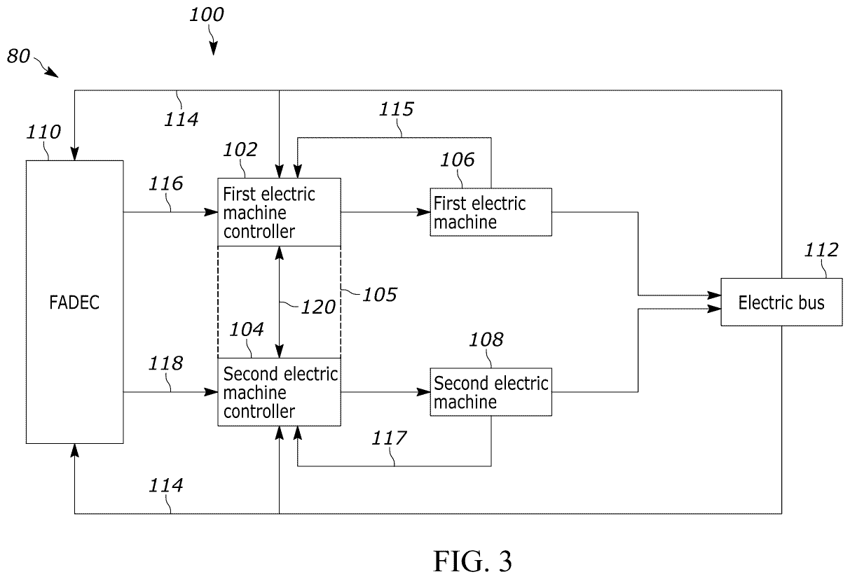

Referring now to FIG. 3, a block diagram of an exemplary electric machine control system 100 is shown. The electric machine control system 100 is part of an engine control system 80 for controlling all aspects of engine operation, which is controlled by the FADEC or EEC 110. For example, the FADEC 110 receives a rate command for an engine such as the turbofan engine 10 and jointly manages the electric machine (EM) dynamics and fuel dynamics of the turbofan engine 10 so that engine dynamics of the turbofan engine 10 produce an output thrust rate from the turbofan engine 10 that is indicated by the rate command. It will be appreciated that the engine control system 80 is usable with engines having either ducted or un-ducted fans. In some embodiments, the rate command can be calculated or generated by the FADEC as a function of a thrust currently being output by the turbofan engine 10 and a newly demanded thrust to be output by the turbofan engine 10 received from one or more aircraft control interfaces. The rate command can be calculated based on the specific hardware capabilities of the turbofan engine 10 to avoid stalling or other dangerous conditions and can take the form of one or more of a thrust, fan, or core speed trajectory.

Further, the FADEC 110 can incorporate various feedback 114 for use in managing the electric machine dynamics and the fuel dynamics. The feedback 114 can include an indication of the current thrust response for the turbofan engine 10 and various parameters of the engine 10. For example, the feedback 114 can include feedback from the electric machines 106, 108, such as a current output and electric machine speed, as well as the voltage of one or more electric buses 112. The FADEC 110 can then modify control of the electric machines 102, 104 and the fuel dynamics to account for the current thrust response as indicated by the feedback 114 and ensure that the turbofan engine 10 achieves a thrust rate as indicated by the rate command while maintaining a demanded voltage on the electric bus 112.

In some embodiments, the electric machines 106, 108 are controlled by one or more electric machine controllers 102, 104 based on control signals from the FADEC 110 to apply positive or negative torque to the shafts 34, 36 of the turbofan engine 10 in the [1-100] kHz frequency ranges, while the slower to respond FADEC 110 provides control signals in the frequency ranges of [1-100] Hz. Accordingly, disturbances to the demanded operation of the electric machines 106, 108 can be responded to significantly faster by the electric machine controller(s) 102, 104, 105 than by the FADEC 110. For example, the electric machine controller or controllers 102, 104, 105 may be configured to simultaneously schedule a current demand for a plurality of electric machines, such as the first and second electric machines 106, 108. “Simultaneously” in this context means that that the current demands for each of the electric machines are output from the electric machine controller or controllers within 2 ms of one another. This allows for disturbances to the system introduced by one or more electric machines 106, 108 to be much more quickly rejected than by the FADEC 110 alone, which in some forms is capable of updating its torque or voltage demands only every 15 ms.

In general operation, a thrust amount and electrical load are set and the engine control system 80 splits application of power within the turbofan engine 10 and to other systems of an aircraft utilizing the engine control system 80. When acceleration is demanded, a new ideal thrust rate is calculated and sent out as a rate command by the FADEC 110. Then, the engine control system 80 measures an error between the ideal rate and an actual rate and dually manages the electric machine dynamics and fuel dynamics to manipulate a power split to minimize the rate error while maintaining the constant total electrical load being demanded by the aircraft. In particular, where the aircraft does not include an energy storage device (e.g., a battery, ultracapacitor, etc.) management of the electric machine dynamics can be limited to a power split between the multiple electric machines 106, 108 in order to maintain the demanded aircraft electrical voltage. However, if an energy storage device is available, management of the electric machine dynamics is not limited to a power split and consequently can be operated with a single electric machine 106, or multiple electric machines 106, 108 can be operated in a positive torque mode to generate additional thrust. Accordingly, when an energy storage device is present, the electric-hybrid architecture, such as shown in FIG. 2, allows for additional flexibility and engine control options. For example, a disturbance to the fan speed can be rejected by modulating a low pressure electric machine 106 while using the energy storage to keep the electric bus voltage and the high pressure electric machine 108 output constant.

As shown in FIG. 3, an electric machine control system 100 in some embodiments includes at least one electric machine controller 102, 105 that directs at least a first electric machine 106 to apply a positive or negative torque to a first engine shaft 36 to which the first electric machine 106 is connected. In some embodiments, a second electric machine controller 104 directs at least a second electric machine 108 to apply a positive or negative torque to a second engine shaft 34 to which the second electric machine 108 is connected. In other embodiments, the first and second electric machine controllers 102, 104 may be integrated into a single electric machine controller 105 that controls both the first and second electric machines 106, 108. When first and second electric machine controllers 102, 104 are present, the electric machine controllers 102, 104 are communicatively coupled via communication line 120. In some embodiments, the electric machine controller 102, 105 controls the first electric machine 106 in response to at least a first electric machine control signal 116 including a demanded first electric machine torque, when the first electric machine 106 is being controlled in a torque mode, or a demanded electric bus voltage of an electric bus 112 to which the first electric machine 106 is connected, when the electric machine 106 is being controlled in a voltage mode. When in voltage mode, the electric machine controller 102, 105 adjusts the positive or negative torque applied by the first electric machine 106 in response to at least one received signal to compensate for disturbances to an electric bus voltage of the electric bus 112 to which the first electric machine 106 is connected. Alternatively, when in torque mode, the electric machine controller 102, 105 adjusts the positive or negative torque applied by the first electric machine 106 in response to at least one received signal to compensate for disturbances to a first engine shaft torque. In some embodiments, the second electric machine controller 104 directs the second electric machine 108 to apply a positive or negative torque to the second engine shaft 34 in response to at least a second electric machine control signal 118 including a demanded second electric machine torque, when the second electric machine 108 is being controlled in a torque mode, or a demanded electric bus voltage of an electric bus 112, 212 to which the second electric machine 108 is connected, when the second electric machine 108 is being controlled in a voltage mode. In some embodiments, the at least one received signal is provided by the second electric machine controller 104. In some embodiments, the at least one received signal includes the second electric machine control signal 118 provided by the FADEC 110 or is derived therefrom. In various embodiments, the received signal corresponds to a second electric machine control signal 118, which may include at least one of a demanded second electric machine torque and a demanded electric bus voltage of an electric bus 112, 212 to which the second electric machine 108 is connected. In some embodiments, the at least one received signal includes feedback 115, 117 from one of the first and/or second electric machines 106, 108 and/or feedback 114 from the electric bus 112, 212.

In some forms, the disturbances introduced to the first engine shaft torque are caused by a change in a torque applied by the second electric machine 108 to the second engine shaft 34. As will be understood, a change in torque may be an increase or decrease in the positive or negative torque applied by the second electric machine 108 to the second engine shaft 34. Although both the first electric machine 106 and second electric machine 108 are shown connected to the same electric bus 112 in FIG. 3, in other embodiments they may be connected to separate electric buses.

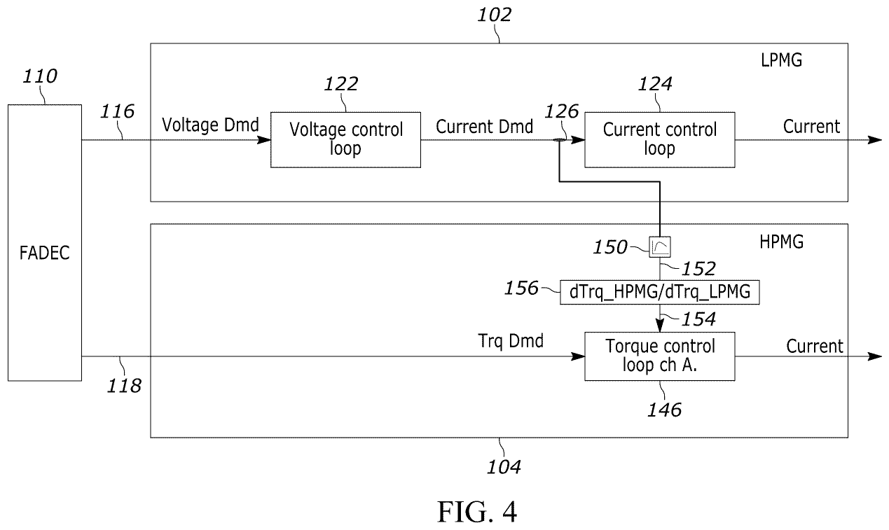

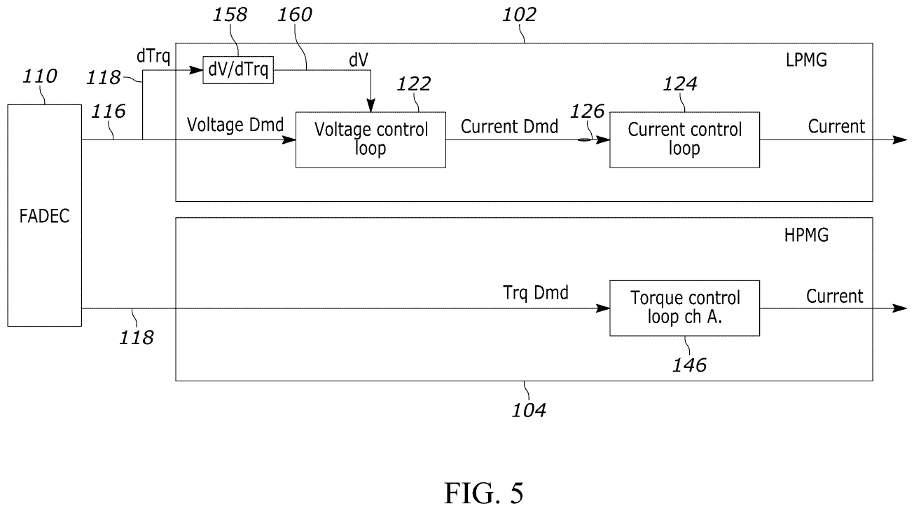

When the first and second electric machines 106, 108 are controlled by separate electric machine controllers 102, 104, different variations of disturbance rejection control can be accomplished, such as shown in FIGS. 4 and 5. In FIG. 4, a one-way disturbance rejection control system is shown in which the second electric machine 108 is configured to reject disturbances introduced by the first electric machine 106 in a voltage mode. In this embodiment, the first electric machine 106 may also be referred to as a low pressure electric machine 106 because it is connected to the low pressure shaft 36. Accordingly, the first electric machine control signal 116 output by the FADEC 110 includes a voltage demand for the electric bus 112 that the first electric machine 106 is to meet. The first or low pressure electric machine controller 102 operated in voltage mode includes an outer voltage control loop 122 and an inner current control loop 124.

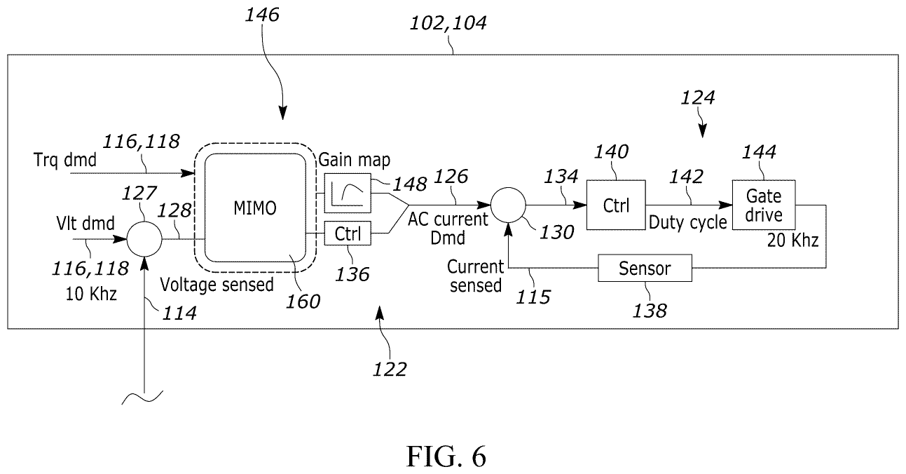

The voltage control loop 122 may be configured substantially as shown in FIG. 6 and includes a controller 136, which may be a PID controller, but may take other forms. Further, the voltage control loop 122 including controller 136 in some embodiments may be replaced by an optional MIMO controller 160 as described in more detail below. However, for the purposes of the discussion below, the MIMO controller 160 is assumed not to be present. The controller 136 determines a demanded current for the first electric machine 106 using an error signal 128 as an input. The error signal 128 is generated by a signal combiner 127 which outputs the difference between the voltage demand 116 and the feedback signal 114 from the electric bus 112, i.e., an instantaneous voltage of the electric bus 112 sensed by a voltage sensor or estimated by an estimator. A current demand 126 determined by the controller 136 is output from the voltage control loop 122, which is fed to a current control loop 124 of the first electric machine controller 102 as shown in FIGS. 4 and 6. An example of the current control loop 124 is also shown in FIG. 6. The current control loop 124 includes a signal combiner 130 which receives the current demand 126 and subtracts a feedback signal 115 therefrom to generate an error signal 134. The feedback signal 115 includes a current sensed by a current sensor 138 of the first electric machine 106. The error signal 134, i.e. the difference between the demanded current 126 and the sensed current 115 is input to a controller 140, which may be a PID controller, although other types of controllers may be used. The controller 140 outputs a control signal 142 to the gate drive 144 of the first electric machine 106, which produces the duty cycle of the output of the first electric machine 106 in accordance with the control signal 142 output by the controller 140. Although the above description was made in reference to the first electric machine controller 102, the second electric machine controller 104 may be similarly configured when in a voltage mode.

A desired voltage holding tolerance can be supplied to adjust the gains of the coupled electric machine controller 102, 104. In particular, the gains of the electric machine controller set its bandwidth, i.e., how fast the electric machine controller 102, 104 will respond to changes in the measured output. Accordingly, supplying a tighter desired voltage holding tolerance would result in a higher gain and higher bandwidth electric machine controller 102, 104.

Referring to FIG. 4, an electric machine control system 100 in some embodiments includes a second electric machine controller 104 in a torque mode that is configured for rejection of disturbances introduced by the first electric machine 102 in a voltage mode. The second electric machine controller 104 controls the second or high pressure electric machine 108 in a torque mode. Accordingly, the second electric machine control signal 118 output by the FADEC 110 includes a torque demand that the second electric machine 108 is to meet, which is the primary input to the torque control loop 146. As shown in FIG. 6, and assuming for this embodiment that the MIMO controller 160 is not present, the torque control loop 146 includes a gain map 148, i.e. a pre-calculated table or function that relates the torque demand 118 to corresponding control gains (such as proportional and integral gains within a PID controller) needed to achieve the demanded torque, essentially mapping different torque levels to optimal control gains for precise torque regulation of the second electric machine 108. As will be understood, the output of the torque control loop 146 is a current demand corresponding to the demanded torque, which is output to a current control loop 124 as described above for controlling the second electric machine 108. Referring again to FIG. 4, an additional input is provided to the torque control loop 146 that corresponds to the change in current demand 126 determined by the first electric machine controller 102. In some embodiments, the second electric machine controller 104 receives the demanded first electric machine torque, which corresponds to the current demand 126. In particular, the change in current demand 126 is fed to a gain map 150 which converts the change current demand 126 to a corresponding change in torque demand dTrq_{_LPMG} 152 of the first electric machine controller 102. The corresponding change in torque demand dTrq_{_LPMG} 152 is then converted via a partial derivative dTrq__{HPMG}/dTrq_{_LPMG} 156 to a corresponding change in torque dTrq_{_HPMG} 154 of the second electric machine 108 necessary to counteract the effect of the voltage control loop 122 and the corresponding current demand 126 of the first electric machine controller 102 on the torque demand 118 of the second electric machine controller 104. As described in more detail below, the partial derivative dTrq_{_HPMG}/dTrq_{_LPMG} 156 may be determined via a disturbance control algorithm to determine how changes in the torque injected to or extracted from the first shaft 36 by the first electric machine 106 affects the torque applied by the second electric machine 108. More particularly, the disturbance rejection control algorithm applied in the embodiment of FIG. 4 is designed to maintain the stability and performance of the torque control of the second electric machine 108. In other embodiments, the second electric machine controller 104 receives as an input the electric bus voltage demanded of the first electric machine instead of the current demand 126 and can compensate for disturbances in a similar manner.

Although the above description was made in reference to the second electric machine controller 104 in a torque mode configured for rejecting disturbances introduced by the first electric machine 106 in a voltage mode, the first electric machine controller 102 may be similarly configured to the second electric machine controller 104 shown in FIG. 4 when in a torque mode and the second electric machine 108 is in a voltage mode. In such embodiments and similar to the configuration shown in FIG. 4, the first electric machine controller 102 receives as inputs the demanded first electric machine torque and the demanded electric bus voltage of an electric bus 112, 212 to which the second electric machine 108 is connected, or the current demand corresponding to the demanded electric bus voltage.

In other embodiments, as shown in FIG. 5, an electric machine control system 100 in some embodiments includes a first electric machine controller 102 in a voltage mode that is configured for rejection of disturbances introduced by the second electric machine 108 in a torque mode. In general, the first electric machine controller 102 receives as inputs the demanded second electric machine torque and the demanded electric bus voltage of an electric bus 112 to which the first electric machine 102 is connected. The second electric machine control signal 118 output by the FADEC 110 includes the torque demand that the second electric machine 108 is to meet, which is the primary input to the torque control loop 146. The torque control loop 146 is configured as previously described with reference to FIG. 6. The first electric machine controller 102 is configured in the same way as described above with reference to FIG. 4, except that an additional input is provided to the voltage control loop 122 that corresponds to a change in torque demand dTrq 118 of the second electric machine controller 104. In particular, the change in torque demand dTrq 118 is converted via a partial derivative dV/dTrq 158 to a corresponding change of voltage dV 160 necessary to counteract the effect of the torque control loop 146 of the second electric machine controller 104 on the voltage demand 116 of the first electric machine controller 102. As described in more detail below, the partial derivative dV/dTrq 158 may be determined via a disturbance control algorithm to determine how changes in the torque injected or extracted from the second shaft 34 by the second electric machine 108 affects the electric bus voltage maintained by the first electric machine 106. More particularly, the disturbance rejection control algorithm is designed to maintain the stability and performance of the electric bus voltage control of the first electric machine 106.

Although the above description was made in reference to the first electric machine controller 102 in a voltage mode configured for rejecting disturbances introduced by the second electric machine 108 in a torque mode, the second electric machine controller 104 may be similarly configured to the first electric machine controller 102 shown in FIG. 5 when the second electric machine 108 is in a voltage mode and the first electric machine 106 is in a torque mode.

In some embodiments, the electric machine controller 105 or each of the first and second electric machine controllers 102, 104 may include or be configured as a multi-input, multi-output (MIMO) controller 160. This control architecture uses demands and feedbacks across the electric machines 106, 108 to compensate for the impact of one electric machine's output on the other(s). Instead of one electric machine controller 102, 104 being configured to reject disturbances while the other electric machine controller operates without disturbance rejection, such as described with respect to FIGS. 4 and 5, each MIMO controller 160 is configured to account for the cross-coupled effects of each of the electric machines 106, 108 on the other by adjusting the torque and/or voltage demands from the FADEC 110 as necessary and can simultaneously schedule the adjusted torque or current demands sent to the electric machines 106, 108. When so configured, the electric machine controller 105 or controllers 102, 104 are configured to simultaneously schedule a change in torque applied by the first electric machine 106 to the first engine shaft 36 with a change in torque applied by the second electric machine 108 to the second engine shaft 34. Such a configuration can be particularly advantageous when the cross-coupled effects of each of the electric machines on each other are more substantial, such as when the torque input and extracted from the shafts 34, 36 by the electric machines 106, 108 are relatively large.

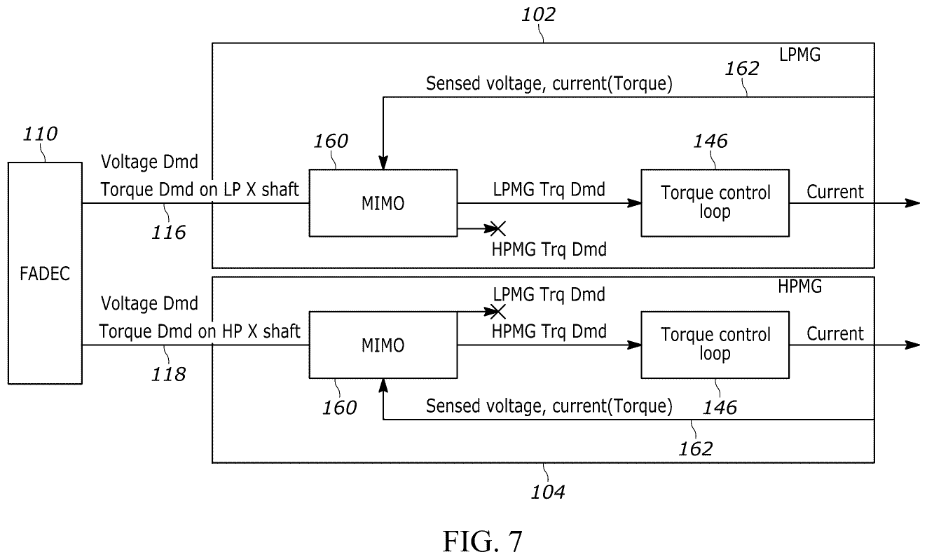

In some embodiments, with reference to FIG. 7, the electric machine control system 100 includes a first electric machine controller 102 and a second electric machine controller 104 for operating a first electric machine 106 and a second electric machine 108, respectively. As in previous examples, the first electric machine 106 may be connected to a low pressure shaft 36 and the second electric machine 108 may be connected to a high pressure shaft 34. Each electric machine controller 102, 104 includes a MIMO controller 160. Each MIMO controller 160 receives at least two inputs and transmits at least two outputs. For example, the MIMO controller 160 of the first electric machine controller 102 receives a torque demand via the first electric machine control signal 116 from the FADEC 110 when the first electric machine 106 is in a torque mode and a voltage demand when the second electric machine 108 is in a voltage mode. In addition, the MIMO controller 160 receives feedback 162, which includes the sensed voltage from the electric bus 112, a current sensed at the first electric machine 106, and a current sensed at the second electric machine 108. The current sensed at the first and second electric machine 106, 108 corresponds to the torque injected or extracted by the electric machines 106, 108. Similarly, the MIMO controller 160 of the second electric machine controller 104 receives a torque demand via the second electric machine control signal 118 from the FADEC 110 when the first electric machine 106 is in a torque mode and a voltage demand when the second electric machine 108 is in a voltage mode. In addition, the MIMO controller 160 receives feedback 162, which includes the sensed voltage from the electric bus 112, a current sensed at the first electric machine 106, and a current sensed at the second electric machine 108. In some embodiments, the feedback 162 may also include a signal indicative of a shaft acceleration of the first and/or second engine shaft 36, 34 which can be used to reject disturbances caused by inertial changes in a desired torque at the respective engine shaft, such as a torque of the first engine shaft 36 caused by inertial changes to a torque of the second engine shaft 34. Each MIMO controller 160 is configured to output a torque demand for the corresponding electric machine 106, 108 to a torque control loop 146 of the electric machine controller 102, 104. The MIMO controller 160 of each electric machine controller 102, 104 may also be configured to output a torque demand for the other electric machine, but as shown, such torque demand simply terminates since it is not needed. The torque control loop 146 may be configured as previously described.

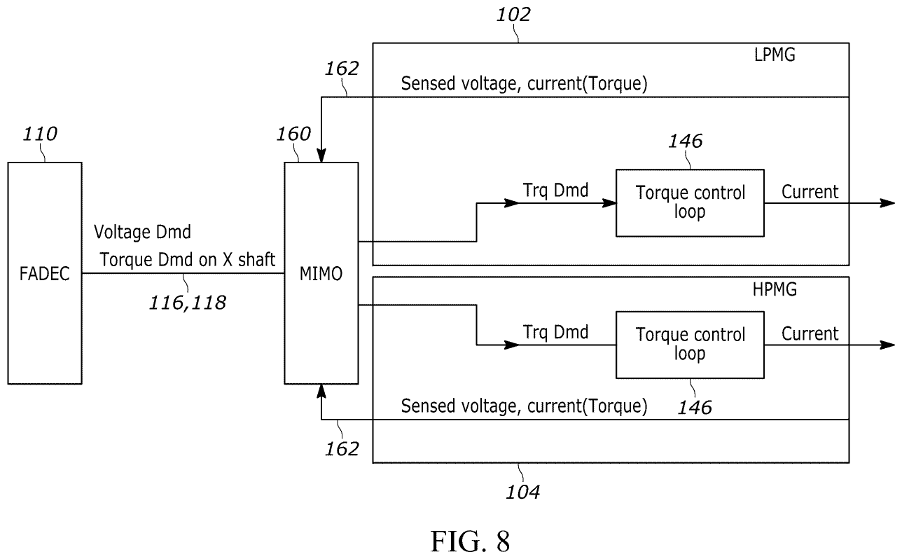

Alternatively, as shown in FIG. 8, the electric machine control system 100 may include a single dedicated MIMO controller 160 that is separate from the first and second electric machine controllers 102, 104 and is configured to control both the first electric machine 106 and the second electric machine 108 in accordance with electric machine control signals 116, 118 received from the FADEC 110 and feedback 162, including the sensed voltage from the electric bus 112, a current sensed at the first electric machine 106, and a current sensed at the second electric machine 108. Similar to the embodiment of FIG. 7, the MIMO controller 160 receives at least two inputs and transmits at least two outputs. For example, the MIMO controller 160 receives a torque demand for one of the electric machines 106, 108 and a voltage demand for the other electric machine 108, 106 when one electric machine is in torque mode and the other electric machine is in voltage mode. The MIMO controller 160 outputs a torque demand for each of the electric machines 106, 108 to a torque control loop 146 of the electric machine controller 102, 104, which may be configured as previously described.

With reference to FIG. 3, in some embodiments, the electric machine control system 100 implements a dynamic inversion control method to calculate a cross-coupled effect of a first electric machine 106 on a control reference 118 of a second electric machine 108. In some embodiments, the control reference 118 is a demanded second electric machine torque or the demanded electric bus voltage of an electric bus 112, 212 to which the second electric machine 108 is connected. In some embodiments, the disturbance rejection control algorithm is implemented to maintain the stability and performance of at least one system parameter, such as a shared electrical bus voltage, where multiple engine shafts, such as engine shafts 34, 36, are coupled to the same electrical bus 112 and are driven by separate electric machines 106, 108. The disturbance control algorithm modifies the torque exerted on one shaft, such as the first shaft 36, based on the torque injected or extracted from another shaft, such as second shaft 34, using a dynamic inversion technique. Dynamic inversion is a control strategy that uses the inverse dynamics of the system to counteract disturbances and maintain desired performance. To implement the control strategy, sensors and/or estimators are used to measure or estimate the torque injected to or extracted from at least one of the engine shafts, such as the first shaft 36. In addition, the voltage of the shared electrical bus 112 is continuously monitored by the corresponding electric machine controller 102, 104 to detect any deviations from the desired setpoint corresponding with the first electric machine control signal 116.

In a first step of the disturbance control algorithm, the torque T₁ injected to or extracted from the first shaft 36 is sensed or estimated. Then, the impact of the torque T₁ on the shared electrical bus voltage V_{bus} is determined, which involves understanding the relationship between torque changes and voltage fluctuations. Next, the desired torque T₂ to be exerted on the second shaft 34 to counteract the disturbance caused by torque T₁ on the shared electrical bus voltage V_{bus} is calculated using dynamic inversion. This involves modeling the system dynamics to understand how changes in T₁ will affect the shared electrical bus voltage V_{bus}. The system dynamics are then inverted to determine the required torque T₂ to be exerted on the second shaft 34 that will bring shared electrical bus voltage V_{bus} back to its desired setpoint. The second electric machine 108 then is directed by the corresponding electric machine controller 104 (or 105) to apply the required torque T₂ to the second shaft 34 to stabilize the electric bus voltage V_{bus}. The electric bus voltage V_{bus} is continuously monitored and the torque T₂ applied to the second shaft 34 is adjusted by the corresponding electric machine controller 104 (or 105) as needed to maintain stability and performance. In other words, the electric machine control system uses a model of the above partial derivatives and a dynamic inversion controller to calculate the off-diagonal effects of the coupled control effectors.

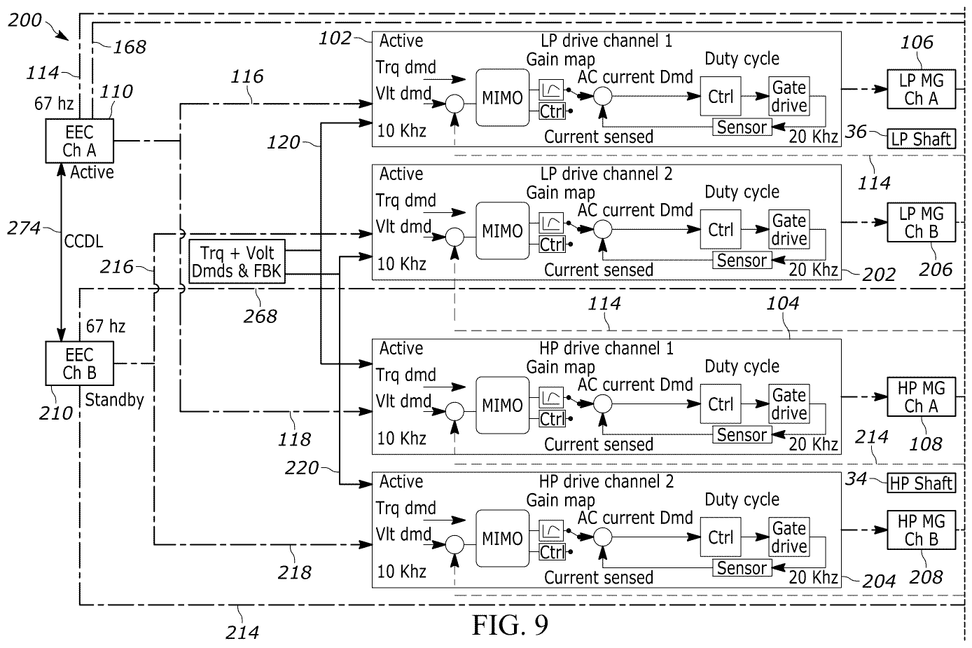

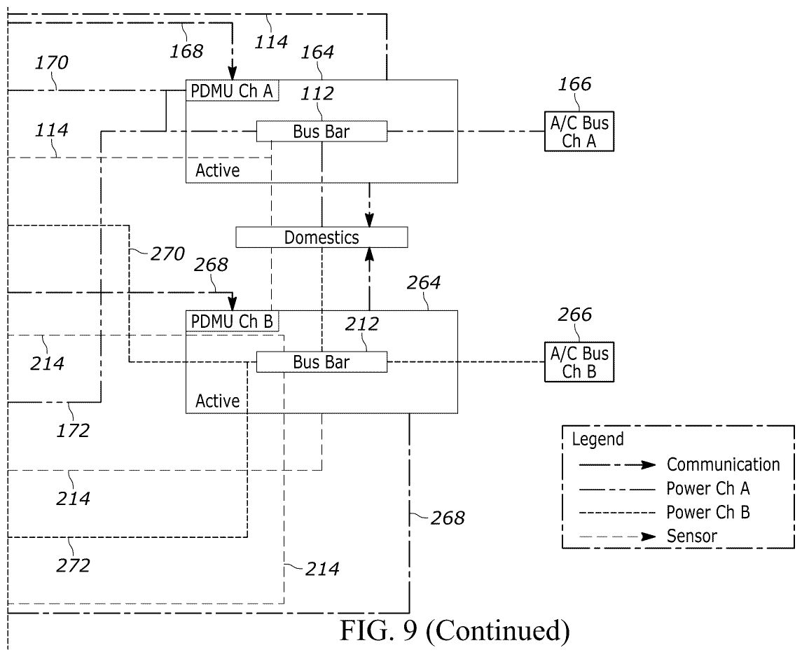

Now referring to FIG. 9, an electric machine control system 200 of a hybrid-electric propulsion system 11 is shown which includes two identical independent channels A and B, each channel being part of a corresponding hybrid-electric turbofan engine 10 of an aircraft. Each channel includes a first electric machine controller 102, 202 and a second electric machine controller 104, 204 configured to control two electric machines 106, 108, 206, 208 for applying a positive or negative torque to first and second engine shafts 36, 34, respectively of each engine 10 in a similar manner to the electric machine control system 100 described with respect to FIG. 3. In other embodiments, the first and second electric machine controllers 102, 104, 202, 204 of each channel may be integrated into a single electric machine controller that controls both the first and second electric machines 106, 108, 206, 208 of each channel.

Each channel includes an EEC or FADEC 110, 210 which provides control signals, i.e. a first electric machine control signal 116, 216 and a second electric machine control signal 118, 218. The EEC or FADEC 110 of channel A is communicatively coupled to the EEC or FADEC 210 of channel B via a Cross Channel Data Link (CCDL) 274. The first and second electric machine controllers 102, 104, 202, 204 of each channel are communicatively coupled via respective communication lines 120, 220 for sharing inputs, e.g. torque and voltage demands and/or feedbacks, e.g. current/torque, bus voltage, shaft acceleration, etc. for rejecting disturbances introduced by the cross-coupled effects of one electric machine on the other as previously described herein.

Each electric machine controller 102, 104, 202, 204 may be configured in accordance with any of the embodiments of the electric machine controllers described herein and may utilize different disturbance rejection techniques including a one-way disturbance rejection control, such as described with respect to FIGS. 4-6. Alternatively, each electric machine controller 102, 104, 202, 204 may utilize distributed MIMO controllers 160 as shown and described with respect to FIGS. 6, 7 and 9. In other forms, a single integrated MIMO controller 160 for each channel may be utilized as shown and described with respect to FIG. 8.

The first electric machine controllers 102, 202 are communicatively coupled to the respective first electric machine 106, 206 and provide control signals thereto in accordance with torque or voltage demands provided by the corresponding EEC or FADEC 110, 210. The first electric machines 106, 206 are each connected to a low pressure shaft 36 of each engine 10 for injecting or extracting torque therefrom.

Similarly, the second electric machine controllers 104, 204 are communicatively coupled to the respective second electric machine 108, 208 and provide control signals thereto in accordance with torque or voltage demands provided by the corresponding EEC or FADEC 110, 210. The electric machines 106, 206 are each connected to a low pressure shaft 36 of each engine 10 for injecting or extracting torque therefrom. The electric machines 106, 108, 206, 208 of each channel are each connected via electrical lines 170, 172, 270, 272 to a respective electric bus 112, 212 for supplying power to or receiving power therefrom. Each electric bus 112, 212 is part of a respective Power Distribution Management Unit (PDMU) 164, 264 which manages the distribution of electrical power and handles data communication within the respective engine 10, including providing fault protection and isolation. Each PDMU 164, 264 is communicatively coupled to a respective EEC or FADEC 110, 210 via communication lines 168, 268. In addition, as discussed above, the EEC 110, 210 and the electric machine controllers 102, 202, 104, 204 can incorporate various feedback 114, 214 for use in managing the electric machine dynamics. Each electric bus 112, 212 is electrically connected to domestic loads 264 e.g., electrical loads of each engine 10, as well as to aircraft buses 166, 266 for powering loads of the aircraft, such as avionics, lighting, instruments, environmental control systems, pumps, etc. In some embodiments, each electric machine 106, 108, 206, 208 may be electrically connected to a single electric bus 112 instead of separate electric buses 112, 212.

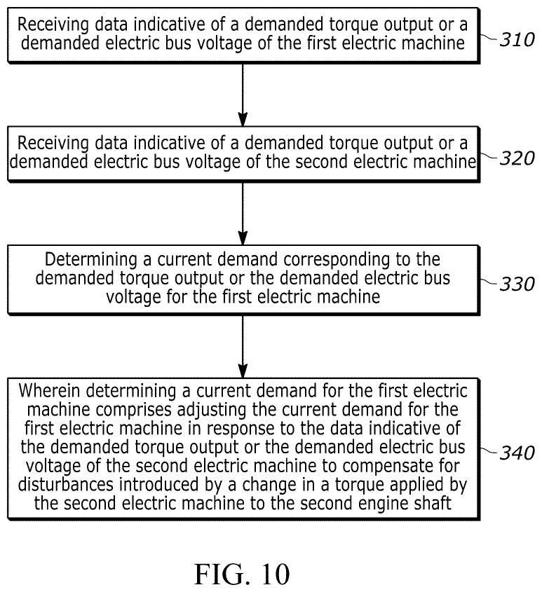

In accordance with various embodiments, a hybrid-electric propulsion system 11 is part of an aircraft and includes at least one engine 10, a first electric machine 106 coupled to a first engine shaft 36 of the engine 10, and a second electric machine 108 coupled to a second engine shaft 34 of the engine 10. Now referring to FIG. 10, a hybrid-electric propulsion system 11 can be operated in some embodiments according to a method including a step 310 of receiving, such as from the FADEC 110, data indicative of a demanded torque output or a demanded electric bus voltage of the first electric machine 106. The method further includes a step 320 of receiving, such as from the FADEC 110 or from an electric machine controller 102, 104, data indicative of a demanded torque output or a demanded electric bus voltage of the second electric machine 108. The method further includes a step 330 of determining a current demand corresponding to the demanded torque output or the demanded electric bus voltage for the first electric machine 106. Determining a current demand for the first electric machine 106 includes a step 340 of adjusting the current demand for the first electric machine 106 in response to the data indicative of the demanded torque output or the demanded electric bus voltage of the second electric machine 108 to compensate for disturbances introduced by a change in a torque applied by the second electric machine 108 to the second engine shaft 34. In some embodiments, the electric machine control system 100, 200 includes one or more electric machine controllers 102, 104, 105, 202, 204 that are programmed with machine-executable instructions to execute the methods described herein.

In some embodiments, the method for operating a hybrid-electric propulsion system of an aircraft includes a step of determining a current demand for the second electric machine 108 corresponding to the demanded torque output or the demanded electric bus voltage of the second electric machine 108. Determining the current demand for the second electric machine 108 in such embodiments includes adjusting the current demand for the second electric machine 108 in response to the data indicative of the demanded torque output or the demanded electric bus voltage of the first electric machine 106 to compensate for disturbances introduced by a change in a torque applied by the first electric machine 106 to the first engine shaft 36.

In some embodiments, the method includes a step of receiving data indicative of an acceleration of the second engine shaft 34 and determining the current demand for the first electric machine 106 includes adjusting the current demand for the first electric machine 106 in response to the data indicative of the acceleration of the second engine shaft 34. In some embodiments, determining a current demand for the first electric machine 106 further includes adjusting the current demand for the first electric machine 106 in response to received data indicative of at least one of: an electric bus voltage of an electric bus 112, 212 to which the first electric machine 106 is connected, an electric bus voltage of an electric bus 112, 212 to which the second electric machine 108 is connected, a current output of the first electric machine, and a current output of the second electric machine 108. In some embodiments, determining a current demand for the first electric machine 106 includes implementing a dynamic inversion control method to calculate a cross-coupled effect of the second electric machine 108 on a control reference of the first electric machine 106, wherein the control reference is the demanded torque output or the demanded electric bus voltage of the first electric machine 106. In some embodiments, determining the current demand for the first electric machine 106 further includes implementing a model of an effect of a torque injected or extracted by the second electric machine 108 to the second shaft 34 on an electric bus voltage of an electric bus 112, 212 to which the first electric machine 106 is connected. In some embodiments, determining the current demand for the first electric machine further includes implementing a model of an effect of a change of a torque of the second engine shaft 34 during an engine transient or an aircraft load transient on an electric bus voltage of an electric bus 112, 212 to which the first electric machine 106 is connected.

FIG. 11 shows a comparison of the performance of a hybrid-electric propulsion system 11 implemented with a prior art electric machine control system (“the prior art system”) and implemented with the electric machine control systems 100, 200 and control methods described herein (“the instant system”) is shown. In both the prior art system and the instant system, a low pressure electric machine 106 is connected to the low pressure shaft 36 and is being operated in a voltage mode to maintain a demanded electric bus voltage 430, and a high pressure electric machine 108 connected to the high pressure shaft 34 is being operated in a torque mode to maintain a demanded torque 470 injected to the high pressure shaft 34. The upper graph shows both an electric bus voltage 410 of the prior art system and the electric bus voltage 420 of the instant system 11 over time before and after a disturbance 440 is introduced, such as an engine transient. The lower graph shows in its upper portion an injected torque 450 to the high pressure shaft 34 by the high pressure electric machine 108 by the prior art system and an injected torque 460 to the high pressure shaft 34 by the high pressure electric machine 108 in accordance with the instant system over time before and after the disturbance 440. The lower portion of the lower graph shows the extracted torque 480 by the low pressure electric machine 106 of the prior art system and the extracted torque 490 by the low pressure electric machine 106 of the instant system.

The behavior of prior art system shown in FIG. 11 will now be described during the following hypothetical scenario. If the FADEC 110 causes the engine 10 to quickly accelerate while a constant aircraft power load is pulled off the electrical bus 112, the following scenario illustrating the cross-coupled effects of the electric machines 106, 108 might ensue. The low pressure electric machine controller 102 controlling a first electric machine 106 connected to the low pressure shaft 36 in voltage mode detects a power increase to the electric bus 112 as the low pressure shaft speed increases and therefore causes the first electric machine 106 to decrease the torque extracted from the low pressure shaft 36 in order to reduce the power supplied to the electrical bus 112. This decrease in torque 480 after the disturbance 440 is visible in the lower plot of the lower graph of FIG. 11. By decreasing the torque extracted from the low pressure shaft 36, the speed of the low pressure shaft 36 increases faster. This increases the air flow to the engine core 16 and causes the high pressure shaft speed to increase. At the same time, if the electric machine controller 105 (or a second electric machine controller 104) is controlling the second electric machine 108 connected to the high pressure shaft 34 to operate in torque mode to inject a desired torque 470 to the high pressure shaft 34, the electric machine controller 102, 104 will cause the second electric machine 108 to increase the injected torque 450 to keep up with the increased speed of the high pressure shaft 34. This increase in injected torque 450 is visible in the upper plot of the lower graph of FIG. 11 to the right of the disturbance 440. However, when the second electric machine 108 increases its torque 450, the electric bus voltage 410 drops further due to the increased electrical demand from the second electric machine 108. Accordingly, the electric machine controller 102, 104 will increase the torque 480 extracted from the low pressure shaft 36 by the first electric machine 106 to compensate for the drop in the electric bus voltage 410. In other words, the coupling effects of the electric machines 106, 108 can cause difficulties in maintaining a desired torque 470 and/or voltage 430, particularly during engine and/or aircraft load transients. In particular, undesired oscillations and perturbations to the torque output of the electric machines 106, 108 and a resulting electric bus voltage 410 can occur.

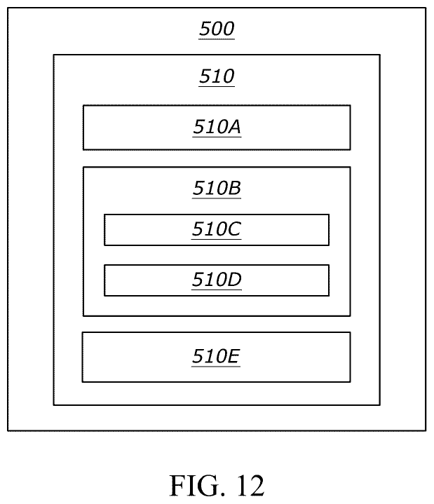

As can be seen from FIG. 12, the prior art system has significantly larger oscillations in both resulting electric bus voltage 410 and in the torque 450 injected by the high pressure electric machine 108 and the torque 480 extracted by the low pressure electric machine 106 compared with the bus voltage 420, injected torque 460, and the extracted torque 490 of the instant system due to the implementation of the systems and methods for rejecting disturbances to the hybrid-electric propulsions system described herein. In addition, the instant system avoids the large electric bus voltage droop and subsequent spike of the prior art system that occurs after the introduction of the disturbance 440. Using the systems and methods for rejecting disturbances described herein, tighter tolerances can be achieved for torque delivered or extracted by the electric machine(s) while reducing voltage droop on the electrical bus during transients.

An electric machine controller 500 in accordance with the various embodiments of electric machine controllers 102, 104, 105, 160, 202, 204 as described previously herein is depicted in FIG. 12. The electric machine controller 500 is configured to receive data from various data sources, such as FADEC or EEC 110, other electric machine controllers, PDMUs 164, 264, and one or more sensors, such as current sensors, voltage sensors, etc. and may make control decisions for the electric machines 106, 108, 206, 208 based on the received data.

In one or more exemplary embodiments, the electric machine controller 500 may be a stand-alone controller for one or more of the electric machines, or alternatively, may be integrated into one or more other controllers for the turbofan engine 10 or into a controller for an aircraft including the turbofan engine 10, etc.

Referring particularly to the operation of the electric machine controller 500, in at least certain embodiments, the electric machine controller 500 can include one or more computing device(s) 510. The computing device(s) 510 can include one or more processor(s) 510A and one or more memory device(s) 510B. The one or more processor(s) 510A can include any suitable processing device, such as a microprocessor, microcontroller, integrated circuit, logic device, and/or other suitable processing device. The one or more memory device(s) 510B can include one or more computer-readable media, including, but not limited to, non-transitory computer-readable media, RAM, ROM, hard drives, flash drives, and/or other memory devices.

The one or more memory device(s) 510B can store information accessible by the one or more processor(s) 510A, including computer-readable instructions 510C that can be executed by the one or more processor(s) 510A. The computer-readable instructions 510C can be any set of instructions that when executed by the one or more processor(s) 510A, cause the one or more processor(s) 510A to perform operations. In some embodiments, the computer-readable instructions 510C can be executed by the one or more processor(s) 510A to cause the one or more processor(s) 510A to perform operations, such as any of the operations and functions for which the electric machine controller 500 and/or the computing device(s) 510 are configured, the operations for the electric machines 106, 108, 206, 208, as described herein, and/or any other operations or functions of the one or more computing device(s) 510. The computer-readable instructions 510C can be software written in any suitable programming language or can be implemented in hardware. Additionally, and/or alternatively, the computer-readable instructions 510C can be executed in logically and/or virtually separate threads on the one or more processor(s) 510A. The one or more memory device(s) 510B can further store data 510D that can be accessed by the one or more processor(s) 510A. For example, the data 510D can include data indicative of power flows, data indicative of engine, electric machine, and/or aircraft operating conditions, and/or any other data and/or information described herein.

The computing device(s) 510 can also include a network interface 510E used to communicate, for example, with the other components of the turbofan engine 10. For example, in the embodiment depicted, as noted above, the turbofan engine 10 includes one or more sensors for sensing data indicative of one or more parameters of the turbofan engine 10 and the electric machines 106, 108, 206, 208. The electric machine controller 500 is operably coupled to the one or more sensors through, e.g., the network interface 510E, such that the electric machine controller 500 may receive data indicative of various operating parameters sensed by the one or more sensors during operation. The network interface 510E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Further aspects of the disclosure are provided by the subject matter of the following clauses:

An electric machine control system, including: an electric machine controller that directs at least a first electric machine to apply a positive or negative torque to a first engine shaft to which the first electric machine is connected in response to a demanded first electric machine torque or a demanded electric bus voltage of an electric bus to which the first electric machine is connected; wherein the electric machine controller adjusts the positive or negative torque applied by the first electric machine in response to at least one received signal to compensate for disturbances to an electric bus voltage of the electric bus to which the first electric machine is connected and/or a first engine shaft torque introduced thereto by a change in a torque applied by a second electric machine to a second engine shaft, wherein the at least one received signal corresponds to at least one of: a demanded second electric machine torque; and a demanded electric bus voltage of an electric bus to which the second electric machine is connected.

The system of the preceding clause, wherein the electric machine controller is operably connected to the second electrical machine and directs the second electric machine to apply a positive or negative torque to the second engine shaft in response to a demanded second electric machine torque or a demanded electric bus voltage of the electric bus to which the second electric machine is connected.

The system of any of the preceding clauses, wherein the electric machine controller is configured as a multi-input, multi-output (MIMO) controller.

The system of any of the preceding clauses, wherein the electric machine controller receives as inputs at least one of the following: the demanded first electric machine torque and the demanded electric bus voltage of the electric bus to which the second electric machine is connected; and the demanded second electric machine torque and the demanded electric bus voltage of the electric bus to which the first electric machine is connected.

The system of any of the preceding clauses, wherein the electric machine controller receives as feedback at least one of a sensed electric bus voltage and a sensed current output of the second electric machine.

The system of any of the preceding clauses, wherein the electric machine controller is configured to simultaneously schedule a change in torque applied by the first electric machine to the first engine shaft with a change in torque applied by the second electric machine to the second engine shaft.

The system of any of the preceding clauses, wherein the electric machine controller is a first electric machine controller; further including a second electric machine controller that directs the second electric machine to apply a positive or negative torque to the second engine shaft in accordance with a demanded second electric machine torque or a demanded electric bus voltage of the electric bus to which the second electric machine is connected.

The system of any of the preceding clauses, wherein the second electric machine controller receives as inputs at least one of the following: the demanded first electric machine torque; and the electric bus voltage demanded of the first electric machine.

The system of any of the preceding clauses, wherein the first electric machine is a low pressure electric machine and the first engine shaft is a low pressure shaft of a turbine engine and the second electric machine is a high pressure electric machine, and the second engine shaft is a high pressure shaft of the turbine engine.

The system of any of the preceding clauses, wherein the electric machine controller receives a signal indicative an acceleration of the second engine shaft and uses the signal indicative of the acceleration of the second engine shaft for rejecting disturbances to a torque of the first engine shaft caused by inertial changes to a torque of the second engine shaft.

The system of any of the preceding clauses, wherein the electric machine controller implements a dynamic inversion control method to calculate a cross-coupled effect of the first electric machine on a control reference of the second electric machine, wherein the control reference is the demanded second electric machine torque or the demanded electric bus voltage of the electric bus to which the second electric machine is connected.

A method for operating a hybrid-electric propulsion system of an aircraft, the hybrid-electric propulsion system including: an engine; a first electric machine coupled to a first engine shaft of the engine; a second electric machine coupled to a second engine shaft of the engine; wherein the method includes: receiving data indicative of a demanded torque output or a demanded electric bus voltage of the first electric machine; receiving data indicative of a demanded torque output or a demanded electric bus voltage of the second electric machine; determining a current demand corresponding to the demanded torque output or the demanded electric bus voltage for the first electric machine; wherein determining a current demand for the first electric machine includes adjusting the current demand for the first electric machine in response to the data indicative of the demanded torque output or the demanded electric bus voltage of the second electric machine to compensate for disturbances introduced by a change in a torque applied by the second electric machine to the second engine shaft.

The method of the preceding clause, further including determining a current demand for the second electric machine corresponding to the demanded torque output or the demanded electric bus voltage of the second electric machine; wherein determining the current demand for the second electric machine includes adjusting the current demand for the second electric machine in response to the data indicative of the demanded torque output or the demanded electric bus voltage of the first electric machine to compensate for disturbances introduced by a change in a torque applied by the first electric machine to the first engine shaft.

The method of any of the preceding clauses, further including scheduling the current demand for the first and second electric machines within 2 ms of each other.

The method of any of the preceding clauses, further including receiving data indicative of an acceleration of the second engine shaft; wherein determining the current demand for the first electric machine includes adjusting the current demand for the first electric machine in response to the data indicative of the acceleration of the second engine shaft.

The method of any of the preceding clauses, wherein determining a current demand for the first electric machine further includes adjusting the current demand for the first electric machine in response to received data indicative of at least one of: an electric bus voltage of an electric bus to which the first electric machine is connected; an electric bus voltage of an electric bus to which the second electric machine is connected; a current output of the first electric machine; and a current output of the second electric machine.

The method of any of the preceding clauses, wherein the first engine shaft is a low pressure engine shaft of the engine and the second engine shaft is a high pressure engine shaft of the engine.

The method of any of the preceding clauses, wherein determining a current demand for the first electric machine includes implementing a dynamic inversion control method to calculate a cross-coupled effect of the second electric machine on a control reference of the first electric machine, wherein the control reference is the demanded torque output or the demanded electric bus voltage of the first electric machine.

The method of any of the preceding clauses, wherein determining the current demand for the first electric machine further comprises implementing a model of an effect of a torque injected to or extracted from the second shaft by the second electric machine on an electric bus voltage of an electric bus to which the first electric machine is connected.

The method of any of the preceding clauses, wherein determining the current demand for the first electric machine further includes implementing a model of an effect of a change of a torque of the second engine shaft during an engine transient or an aircraft load transient on an electric bus voltage of an electric bus to which the first electric machine is connected.

1. An electric machine control system, comprising:
an electric machine controller that directs at least a first electric machine to apply a positive or negative torque to a first engine shaft to which the first electric machine is connected in response to a demanded first electric machine torque or a demanded electric bus voltage of an electric bus to which the first electric machine is connected,
wherein the electric machine controller adjusts the positive or negative torque applied by the first electric machine in response to at least one received signal to compensate for disturbances to at least one of an electric bus voltage of the electric bus to which the first electric machine is connected or a first engine shaft torque introduced thereto by a change in a torque applied by a second electric machine to a second engine shaft,
wherein the at least one received signal corresponds to at least one of:
a demanded second electric machine torque; or
a demanded electric bus voltage of an electric bus to which the second electric machine is connected,
wherein the electric machine controller receives control signals from a primary engine controller, and
wherein the electric machine controller operates at a rate faster than the primary engine controller to compensate for disturbances.

2. The electric machine control system of claim 1, wherein the electric machine controller is operably connected to the second electric machine and directs the second electric machine to apply a positive or negative torque to the second engine shaft in response to a demanded second electric machine torque or a demanded electric bus voltage of the electric bus to which the second electric machine is connected.

3. The electric machine control system of claim 1, wherein the electric machine controller is configured as a multi-input, multi-output (MIMO) controller.

4. The electric machine control system of claim 1, wherein the electric machine controller receives as inputs at least one of the following:
the demanded first electric machine torque and the demanded electric bus voltage of the electric bus to which the second electric machine is connected; and
the demanded second electric machine torque and the demanded electric bus voltage of the electric bus to which the first electric machine is connected.

5. The electric machine control system of claim 1, wherein the electric machine controller receives as feedback at least one of a sensed electric bus voltage and a sensed current output of the second electric machine.

6. The electric machine control system of claim 1, wherein the electric machine controller is configured to simultaneously schedule a change in torque applied by the first electric machine to the first engine shaft with a change in torque applied by the second electric machine to the second engine shaft.

7. The electric machine control system of claim 1, wherein the electric machine controller is a first electric machine controller,
the electric machine control system further comprising a second electric machine controller that directs the second electric machine to apply a positive or negative torque to the second engine shaft in accordance with a demanded second electric machine torque or a demanded electric bus voltage of the electric bus to which the second electric machine is connected.

8. The electric machine control system of claim 7, wherein the second electric machine controller receives as inputs at least one of the following:
the demanded first electric machine torque; and
the electric bus voltage demanded of the first electric machine.

9. The electric machine control system of claim 1, wherein the first electric machine is a low pressure electric machine and the first engine shaft is a low pressure shaft of a turbine engine and the second electric machine is a high pressure electric machine, and the second engine shaft is a high pressure shaft of the turbine engine.

10. The electric machine control system of claim 1, wherein the electric machine controller receives a signal indicative of an acceleration of the second engine shaft and uses the signal indicative of the acceleration of the second engine shaft to reject disturbances to a torque of the first engine shaft caused by inertial changes to a torque of the second engine shaft.

11. The electric machine control system of claim 1, wherein the electric machine controller implements a dynamic inversion control method to calculate a cross-coupled effect of the first electric machine on a control reference of the second electric machine, and wherein the control reference is the demanded second electric machine torque or the demanded electric bus voltage of the electric bus to which the second electric machine is connected.

12. A method for operating a hybrid-electric propulsion system of an aircraft,
the hybrid-electric propulsion system comprising:
an engine;
a first electric machine coupled to a first engine shaft of the engine; and
a second electric machine coupled to a second engine shaft of the engine, and
the method comprising:
receiving data indicative of a demanded torque output or a demanded electric bus voltage of the first electric machine;
receiving data indicative of a demanded torque output or a demanded electric bus voltage of the second electric machine; and
determining a current demand corresponding to the demanded torque output or the demanded electric bus voltage for the first electric machine,
wherein determining a current demand for the first electric machine comprises adjusting the current demand for the first electric machine in response to the data indicative of the demanded torque output or the demanded electric bus voltage of the second electric machine to compensate for disturbances introduced by a change in a torque applied by the second electric machine to the second engine shaft.

13. The method of claim 12, further comprising:
determining a current demand for the second electric machine corresponding to the demanded torque output or the demanded electric bus voltage of the second electric machine,
wherein determining the current demand for the second electric machine comprises adjusting the current demand for the second electric machine in response to the data indicative of the demanded torque output or the demanded electric bus voltage of the first electric machine to compensate for disturbances introduced by a change in a torque applied by the first electric machine to the first engine shaft.

14. The method of claim 13, further comprising scheduling the current demand for the first and second electric machines within 2 ms of each other.

15. The method of claim 12, further comprising receiving data indicative of an acceleration of the second engine shaft,
wherein determining the current demand for the first electric machine comprises adjusting the current demand for the first electric machine in response to the data indicative of the acceleration of the second engine shaft.

16. The method of claim 12, wherein determining a current demand for the first electric machine further comprises adjusting the current demand for the first electric machine in response to received data indicative of at least one of:
an electric bus voltage of an electric bus to which the first electric machine is connected;
an electric bus voltage of an electric bus to which the second electric machine is connected;
a current output of the first electric machine; or
a current output of the second electric machine.

17. (canceled)

18. The method of claim 12, wherein determining a current demand for the first electric machine comprises implementing a dynamic inversion control method to calculate a cross-coupled effect of the second electric machine on a control reference of the first electric machine, wherein the control reference is the demanded torque output or the demanded electric bus voltage of the first electric machine.

19. The method of claim 12, wherein determining the current demand for the first electric machine further comprises implementing a model of an effect of a torque injected to or extracted from the second shaft by the second electric machine on an electric bus voltage of an electric bus to which the first electric machine is connected.

20. The method of claim 18, wherein determining the current demand for the first electric machine further comprises implementing a model of an effect of a change of a torque of the second engine shaft during an engine transient or an aircraft load transient on an electric bus voltage of an electric bus to which the first electric machine is connected.

21. The method of claim 12, wherein determining the current demand for the first electric machine is performed by an electric machine controller that receives control signals from a primary engine controller and that operates at a rate faster than the primary engine controller to compensate for disturbances.
